(19) United States
(12) Patent Application Publication
(10) Pub. No.: US 2015/0143426 A1
(43) Pub. Date: May 21, 2015

(54) ELECTRONIC PROGRAM LIST OPERATION SYSTEM APPLIED TO PORTABLE ELECTRONIC DEVICE AND OPERATION METHOD THEREOF

(71) Applicant: Asia Vital Components Co., Ltd., New Taipei City (TW)

(72) Inventor: Chih-Heng Shan, New Taipei City (TW)

(73) Assignee: Asia Vital Components Co., Ltd., New Taipei City (TW)

(21) Appl. No.: 14/085,282

(22) Filed: Nov. 20, 2013

(51) Int. Cl. H04N 21/422; H04N 21/458; H04N 21/482; H04N 21/462; H04N 21/41; H04N 21/431

(52) U.S. Cl. CPC H04N 21/4222; H04N 21/4126; H04N 21/431; H04N 21/4821; H04N 21/462; H04N 21/4586
USPC 725/50

(57) ABSTRACT

An electronic program list operation system applied to portable electronic device and an operation method thereof. The electronic program list operation system includes a controlled device, at least one portable electronic device and a wireless transmission module. The portable electronic device is wirelessly connected to a network platform for readily downloading and updating program list information, whereby a user can check the program list information on the portable electronic device and input an operation command to select a desired channel. The wireless transmission module serves to transmit at least one remote control signal to the corresponding controlled device to switch to the selected channel. Accordingly, a user can browse the program list information on the portable electronic device and immediately switch to the selected channel for watching a desired program.

### BACKGROUND OF THE INVENTION

1. Field of the Invention

The present invention relates generally to an electronic program list operation system applied to portable electronic device and an operation method thereof. By means of the electronic program list operation system, a user can browse the program list information on the portable electronic device and immediately conveniently switch to a selected channel for watching a desired program.

2. Description of the Related Art

Conventionally, when a subscriber watches the programs of an analog television, the subscriber generally first browses the program list shown on a newspaper or checks all the channels one by one to see whether there is any desired program. This is quite time-consuming and inefficient. Currently, with respect to cable television, a user can check the program list in a certain fixed channel. The program list is shown in such a manner that a menu containing multiple channels, time and program contents is shown in the fixed channel. The program contents of different channels are sequentially repeatedly shown in the fixed channel at a fixed frequency (such as 3 seconds). Therefore, every time a user wants to know the program information of a certain channel during a certain time period, the user must first switch to the fixed channel for finding the program information. As aforesaid, the program contents of different channels are sequentially repeatedly shown in the fixed channel at a fixed frequency. As a result, the user often needs to wait for a long time before the program contents of a desired channel are shown.

It is known that intelligent cell phones have become inevitable personal communication tools in modern life. Therefore, some manufacturers have developed a technique for loading the program list information into an intelligent cell phone, whereby a user can quickly check the program list information on the intelligent cell phone and then select a desired channel via a remote controller. This measure solves the problem that a user needs to wait for a long time before the program contents of a desired channel are shown. However, it is still inconvenient to use the intelligent cell phone to check the program list information and select the desired channel. This is because that when checking the program list information on the intelligent cell phone, a user needs to hold the intelligent cell phone with one hand to watch (or check) the program list information, while hold the remote controller with the other hand to switch to the desired channel. This is inconvenient to the user.

### SUMMARY OF THE INVENTION

It is therefore a primary object of the present invention to provide an electronic program list operation system applied to portable electronic device. By means of the electronic program list operation system, a user can browse the program list information on the portable electronic device and immediately switch to a selected channel for watching a desired program.

It is a further object of the present invention to provide the above electronic program list operation system applied to portable electronic device. By means of the electronic program list operation system, a user can more conveniently check the program list information on the portable electronic device and immediately switch to a selected channel for watching a desired program.

It is still a further object of the present invention to provide an electronic program list operation method applied to portable electronic device. By means of the electronic program list operation method, a user can browse the program list information on the portable electronic device and immediately switch to a selected channel for watching a desired program.

It is still a further object of the present invention to provide the above electronic program list operation method applied to portable electronic device. By means of the electronic program list operation method, a user can more conveniently check the program list information on the portable electronic device and immediately switch to a selected channel for watching a desired program.

To achieve the above and other objects, the electronic program list operation system applied to portable electronic device of the present invention includes at least one controlled device, at least one portable electronic device and a wireless transmission module electrically connected to the portable electronic device. The controlled device serves to execute corresponding operation according to at least one received remote control signal. The portable electronic device is wirelessly connected to a network platform for readily downloading and updating program list information transmitted from the network platform. The portable electronic device includes a microprocessor unit, a storage unit and a display input unit. The storage unit stores therein at least one application software and at least one remote control code. The program list information is loaded in the application software. The remote control code is correspondingly connected to multiple channels in the program list information. The display input unit serves to display the program list information loaded in the application software for a user to check and input an operation command to select a desired channel.

The microprocessor unit is connected to the storage unit and the display input unit. The microprocessor unit serves to receive the operation command and convert the remote control code corresponding to the selected channel into at least one remote control signal. The wireless transmission module serves to receive the remote control signal and transmit the remote control signal to the controlled device. By means of the electronic program list operation system, a user can browse the program list information on the portable electronic device and immediately conveniently switch to a selected channel for watching a desired program.

The present invention also provides an electronic program list operation method applied to portable electronic device. The portable electronic device is wirelessly connected to a network platform. The portable electronic device includes a microprocessor unit, a storage unit and a display input unit. The storage unit stores therein at least one application software and at least one remote control code. The electronic program list operation method includes steps of: using the portable electronic device to readily download and update program list information transmitted from the network platform and loading the program list information into the application software; displaying the program list information in the application software via the display input unit for a user to check and input an operation command to select desired channels; using the microprocessor unit to receive the operation command and convert the remote control codes corresponding to the selected channels in the program list information into at least one remote control signal, a wireless transmission module being used to transmit the remote control signal to a corresponding controlled device; and the controlled device executing corresponding operation according to the received remote control signal. By means of the electronic program list operation method, a user can browse the program list information on the portable electronic device and immediately conveniently switch to a selected channel for watching a desired program.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a first embodiment of the present invention;

FIG. 2 is a perspective view of the portable electronic device of the first embodiment of the present invention;

FIG. 3 is a view showing the use of the first embodiment of the present invention;

FIG. 4 is another view showing the use of the first embodiment of the present invention;

FIG. 5A is a perspective assembled view of the portable electronic device of the second embodiment of the present invention;

FIG. 5B is a perspective exploded view of the portable electronic device of the second embodiment of the present invention; and

FIG. 6 is a flow chart of the electronic program list operation method applied to portable electronic device of the present invention.

### DETAILED DESCRIPTION OF THE PREFERRED EMBODIMENTS

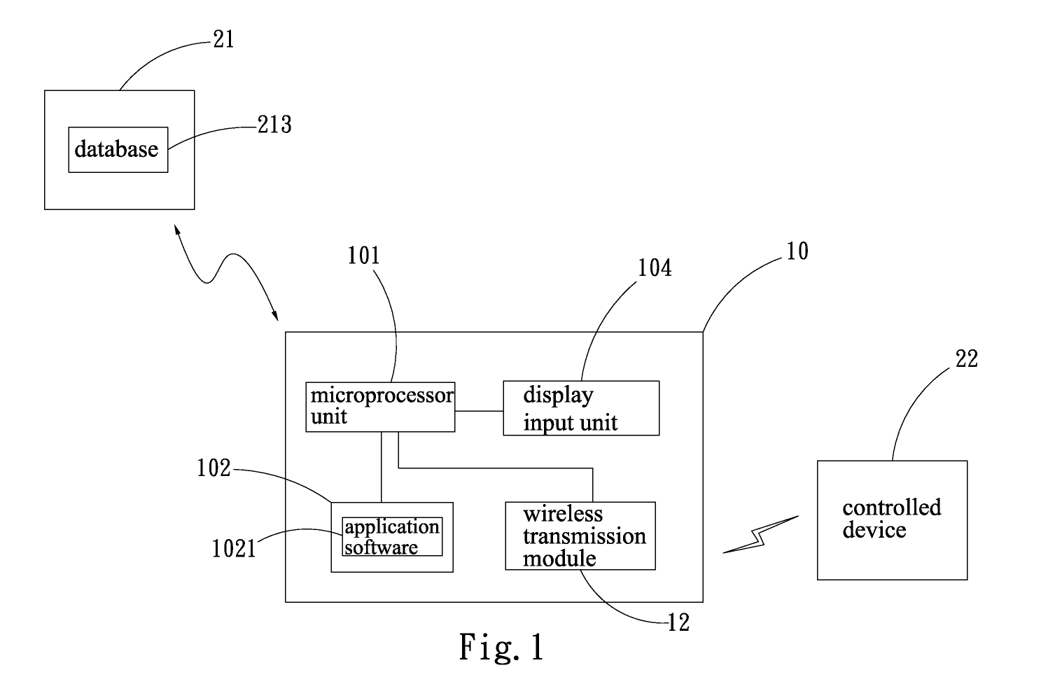

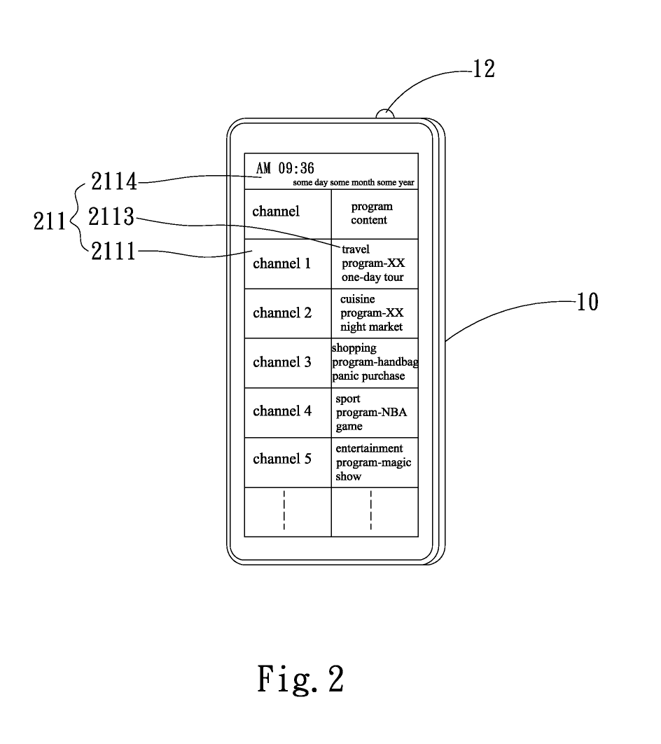

Please refer to FIGS. 1 and 2. FIG. 1 is a block diagram of a first embodiment of the present invention. FIG. 2 is a perspective view of the portable electronic device of the first embodiment of the present invention. According to the first embodiment, the electronic program list operation system applied to portable electronic device of the present invention includes at least one controlled device 22, at least one portable electronic device 10 and a wireless transmission module 12. In this embodiment, the portable electronic device 10 is, but not limited to, an intelligent cell phone for illustration purposes only. In practice, the portable electronic device 10 alternatively can be any of a tablet, a notebook and a personal digital assistant (PDA).

The portable electronic device 10 is wirelessly connected to a network platform 21 for readily downloading and updating program list information 211 transmitted from the network platform 21. The program list information 211 contains multiple channels 2111, multiple program contents 2113 and time data 2114. The program contents 2113 and time data 2214 correspond to the channels 2111. For example, a travel program introducing one-day tour of a certain place is broadcast in channel 1 at some time on some day. A cuisine program introducing a certain night market is broadcast in channel 2 at some time on some day. A shopping program introducing handbag panic purchase is broadcast in channel 3 at some time on some day, etc.

The way to wirelessly connect the network platform 21 to the portable electronic device 10 can be any of 3G, 4G, WIMAX and WIFI. In this embodiment, the network platform 21 is, but not limited to, a server for illustration purposes only. In practice, the network platform 21 can be any platform serving for the portable electronic device 10 to readily download and update the program list information 211, such as network store (such as App store and Android Market).

The network platform 21 includes a database 213 for storing and organizing (or collecting) multiple television station program data. The network platform 21 is connected to multiple television stations via a wired network or a wireless network for readily updating the program data of every television station in the database 213 and converting the program data into the program list information 211. The wired network is Ethernet and the wireless network is WIMAX or WIFI.

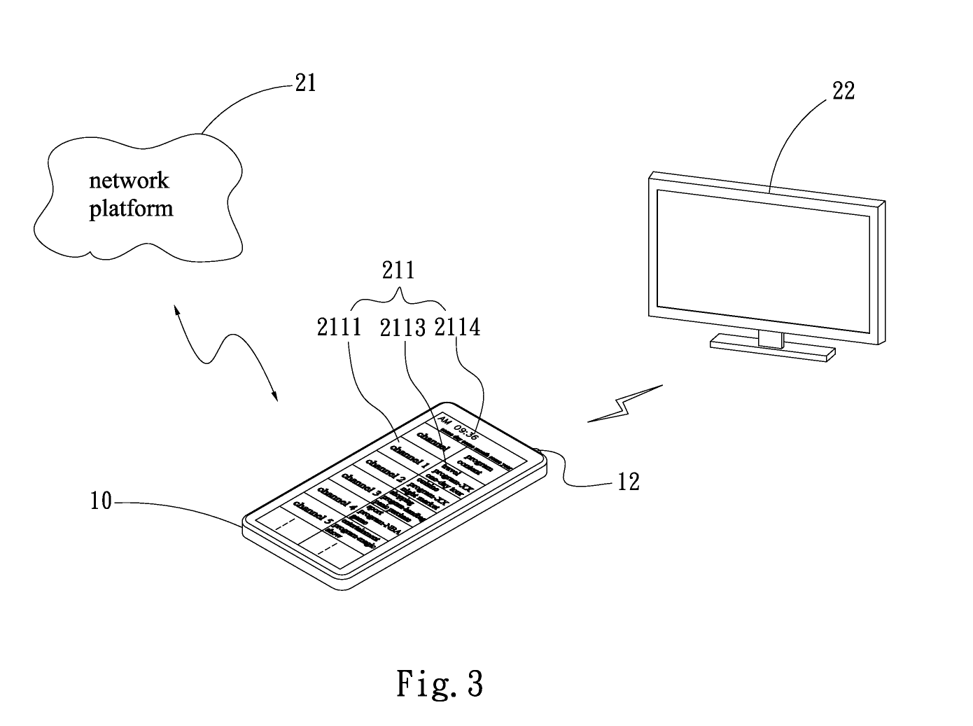

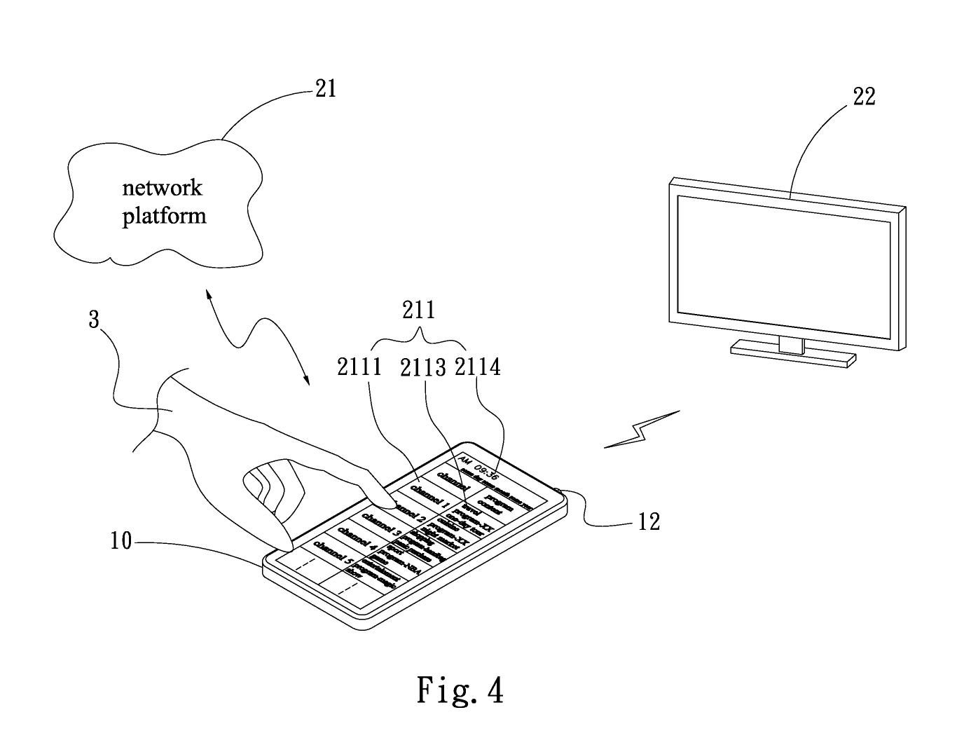

Please refer to FIGS. 1 and 3 as well as FIG. 4. The portable electronic device 10 includes a microprocessor unit 101, a storage unit 102 and a display input unit 104. The storage unit 102 is a memory such as RAM, DRAM, ROM or a memory card (such as an SD card or a MicroSD card). The storage unit 102 stores therein at least one application software 1021 and at least one remote control code. The program list information 211 is loaded in the application software 1021. The remote control code is correspondingly connected to the channels 2111 in the program list information 211. That is, for example, channel 1 corresponds to the remote control code for switching to channel 1, channel 2 corresponds to the remote control code for switching to channel 2, etc.

Also, the remote control code corresponds to the remote control encoding data of the controlled device 22 (such as a television). That is, multiple remote control codes correspond to the remote control encoding data of the controlled electrical product (such as a television).

The display input unit 104 is a touch display panel for displaying the program list information 211 loaded in the application software 1021 for a user 3 to check (or browse) and input an operation command on the display input unit 104 to, for example, select one of the channels 2111 of the program list information on the display input unit 104). That is, the user 3 checks (or browses) the program list information 211 of the application software 1021 displayed on the touch display panel. In the case that the user 3 finds a desired program, the user 3 can immediately touch and select the channel 2111 of the program list information 211 on the touch display panel.

Please refer to FIGS. 1 and 3. The microprocessor unit 101 is electrically connected to the storage unit 102 and the display input unit 104. The microprocessor unit 101 receives the operation command and converts the remote control code corresponding to the selected channel 2111 into at least one remote control signal. For example, in the case that the selected channel 2111 is channel 1, according to the remote control code corresponding to channel 1, the microprocessor unit 101 will convert the remote control code into a remote control signal. In the case that the selected channels 2111 are channels 1 and 2, according to the remote control codes corresponding to channels 1 and 2, the microprocessor unit 101 will continuously convert the remote control codes into two remote control signals. (That is, the microprocessor unit 101 will first convert the remote control code corresponding to channel 1 into a remote control signal and then convert the remote control code corresponding to channel 2 into another remote control signal.)

The remote control signal is a signal encoded and modulated by the microprocessor unit 101. In addition, the signal is coupled with the output signal form of the wireless transmission module 12 electrically connected to the microprocessor unit 101. In this embodiment, the wireless transmission module 12 is, but not limited to, an infrared transmission module for illustration purposes only and the coupled remote control signal is an infrared remote control signal. In practice, alternatively, the wireless transmission module 12 can be a radio transmission module and the coupled remote control signal is a radio remote control signal. Still alternatively, the wireless transmission module 12 can be a laser transmission module and the coupled remote control signal is a laser remote control signal.

In this embodiment, the wireless transmission module 12 is disposed on one side of the portable electronic device 10 and electrically connected to the microprocessor unit 101 of the portable electronic device 10. The wireless transmission module 12 serves to receive the remote control signal from the microprocessor unit 101 and wirelessly transmit the signal to the corresponding controlled device 22. The controlled device 22 receives the remote control signal to execute corresponding operation. For example, in the case that the controlled device 22 is a television, when the television receives the remote control signal, the channel is switched to channel 1, channel 2 or some other channel.

The following is an example for illustration:

Please refer to FIGS. 1 and 4, when a user 3 holds the portable electronic device 10 with one hand and checks (or browses) the program list information 211 loaded in the application software 1021 on the display input unit 104, the portable electronic device 10 will readily download and update the program list information 211 from the wirelessly connected network platform 21. At this time, in the case that the user 3 finds a desired channel 2111 (such as channel 1) in the program list information 211, the user 3 can touch (or select) the channel 2111 in the program list information 211 displayed by the display input unit 104 with a finger. At this time, the microprocessor unit 101 receives the operation command, (that is, the touch of the finger to the channel 2111 in the program list information 211 displayed by the display input unit 104) to convert the remote control code corresponding to the channel 2111 into the remote control signal. Then the wireless transmission module 21 wirelessly transmits the remote control signal to the corresponding controlled device 22. According to the received remote control signal, the controlled device 22 switches the channel to the channel 2111 desired to watch by the user 3. Therefore, the user can browse the program list to readily remote control the controlled device 22 to switch to the desired channel 2111. Accordingly, the use of the portable electronic device 10 is facilitated.

According to the design of the system of the present invention, the user 3 can browse or check the program list information 211 with one hand and immediately remote control the controlled device 22 to switch to the selected channel for watching a desired program. Therefore, the portable electronic device 10 can be conveniently used.

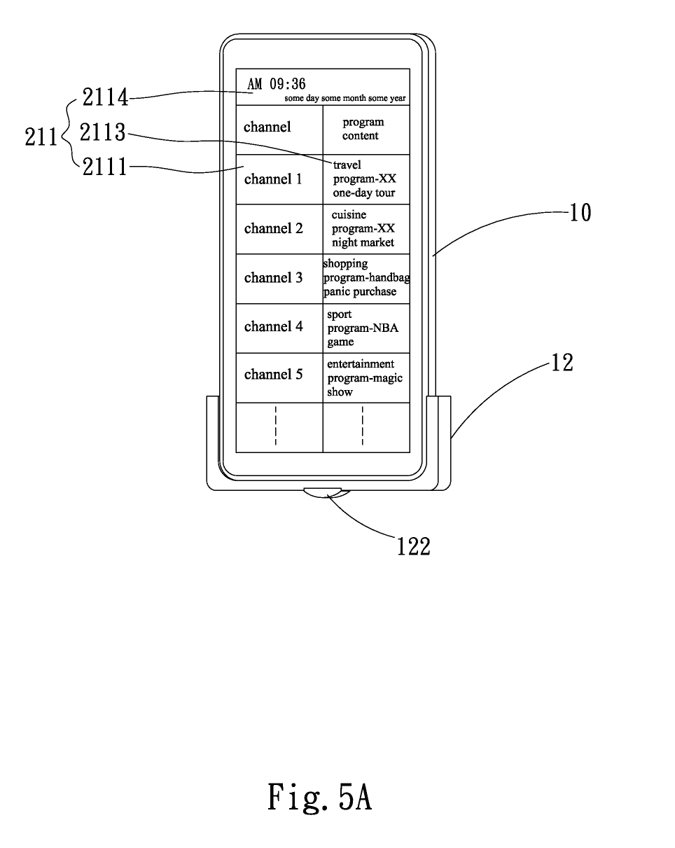

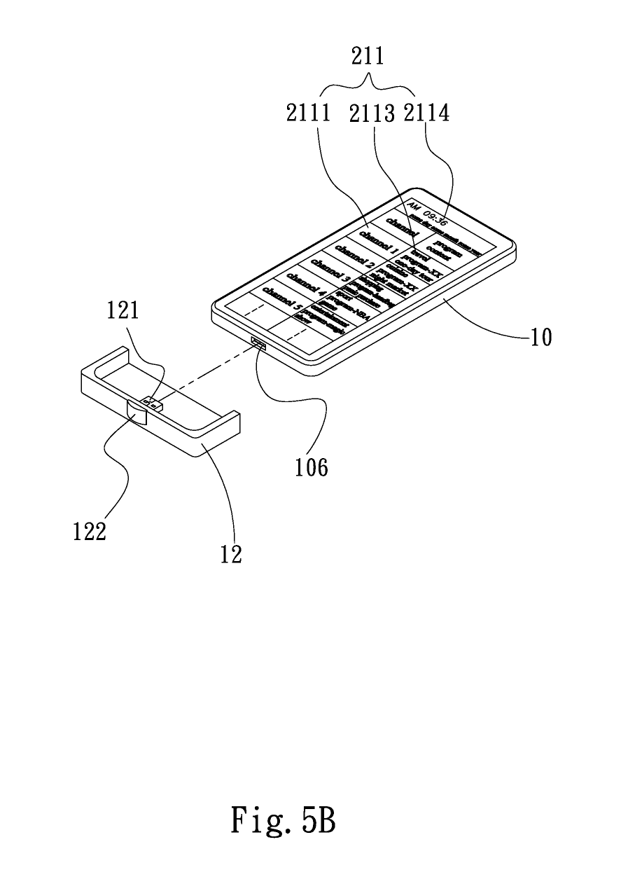

Please now refer to FIGS. 5A and 5B. FIG. 5A is a perspective assembled view of the portable electronic device of the second embodiment of the present invention. FIG. 5B is a perspective exploded view of the portable electronic device of the second embodiment of the present invention. The second embodiment is substantially identical to the first embodiment in structure, connection relationship and effect and thus will not be repeatedly described hereinafter. In the first embodiment, the wireless transmission module 12 is disposed on one side of the portable electronic device 10. Instead, in the second embodiment, the wireless transmission module 12 is an independent component electrically mated with the portable electronic device 10. The way to electrically mate the wireless transmission module 12 with the portable electronic device 10 can be thermal insertion/extraction electrical connection, joint electrical connection or engagement electrical connection.

That is, the wireless transmission module 12 is a case, a cartridge or a column body, having a mating section 121 and a transmission member 122. The mating section 121 is disposed on one side of the wireless transmission module 12 for mating with a connection section 106 of the portable electronic device 10. In this embodiment, the transmission member 122 is, but not limited to, an infrared transmission member for illustration purposes only. In practice, the transmission member 122 can be alternatively a radio transmission member or a laser transmission member.

The mating section 121 is coupled with the connection section 106 in a connection form, which is, but not limited to, a connection port in conformity to universal serial bus (USB) form for illustration purposes only. Alternatively, the connection form can be a connection port in conformity to Micro USB form, Mini USB form, SATA form, e-SATA form, RJ-45 form, HDMI form, Dock form, (that is, the 30-pin or 9-pin Dock of any of iphone, ipod and ipad of Apple), or 3.5 mm earphone plug.

The transmission member 122 is disposed on the other side of the wireless transmission module 12. The transmission member 122 serves to receive the remote control signal from the microprocessor unit 101 and wirelessly transmit the signal to the corresponding controlled device 22. The controlled device 22 receives the remote control signal to execute corresponding operation. Accordingly, a user can browse the program list information 211 and immediately remote control the controlled device 22 to switch to the selected channel for watching a desired program. Therefore, the portable electronic device 10 can be conveniently used.

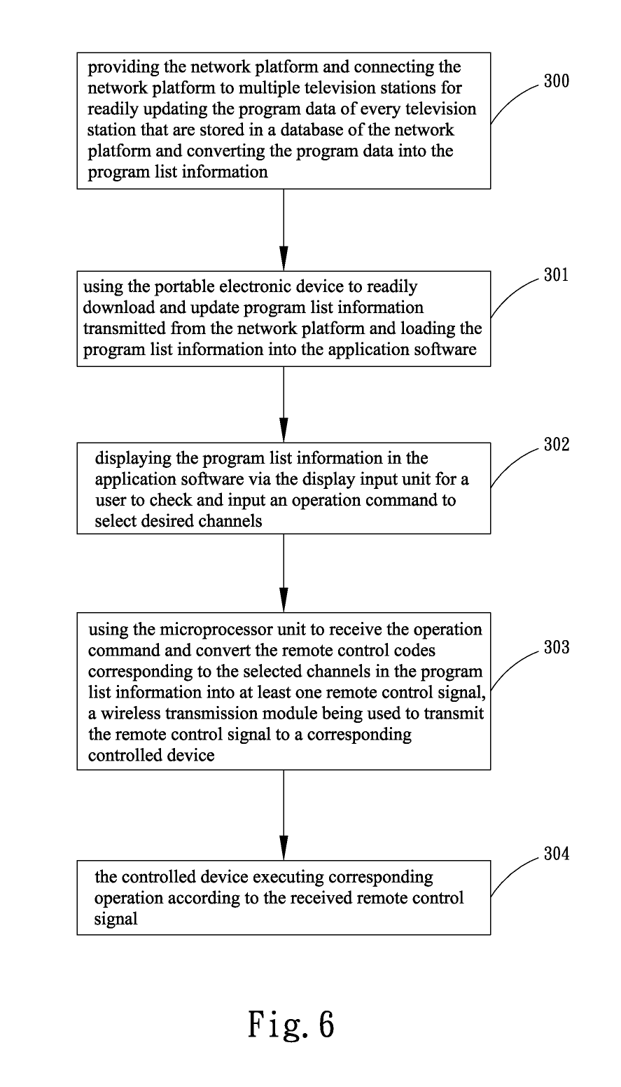

Please now refer to FIG. 6, which is a flow chart of the electronic program list operation method applied to portable electronic device of the present invention. Also referring to FIGS. 1 to 5B, the operation method includes steps of:

300. providing a network platform and connecting the network platform to multiple television stations for readily updating the program data of every television station that are stored in a database of the network platform and converting the program data into the program list information, the network platform 21 being provided, in this embodiment, the network platform 21 being, but not limited to, a server for illustration purposes only, in practice, the network platform 21 alternatively being a network store, the network platform 21 being connected to multiple television stations via a wired network or a wireless network for readily updating the program data of every television station that are stored in the database 213 of the network platform 21 and converting the program data into the program list information 211;

301. readily downloading and updating the program list information transmitted from the network platform via the portable electronic device and loading the program list information into the application software, a user 3 wirelessly connecting the portable electronic device 10 to the network platform 21 (by means of 3G, 4G, WIMAX or WIFI) for readily downloading and updating the program list information 211 transmitted from the network platform 21 and loading the received program list information 211 into the application software 1021 of the portable electronic device 10, the program list information 211 containing multiple channels 2111, multiple program contents 2113 and time data 2114, the program contents 2113 and time data 2214 corresponding to the channels 2111;

302. displaying the program list information in the application software via the display input unit for a user to check and input an operation command, the user 3 checking (or browsing) the program list information 211 in the application software 1021 displayed on the display input unit 104 of the portable electronic device 10, in the case that the user 3 finds a desired channel 2111 (such as channel 2) in the program list information 211, the user 3 immediately inputting an operation command on the display panel (by means of touching and selecting the channel 2111 of the program list information 211);

303. using the microprocessor unit to receive the operation command and convert the remote control codes corresponding to the selected channels in the program list information into at least one remote control signal, a wireless transmission module being used to transmit the remote control signal to a corresponding controlled device, the microprocessor unit 101 of the portable electronic device 10 serving to receive the operation command and convert the remote control code corresponding to the selected channel 2111 (such as channel 2) in the program list information 211 into the remote control signal, the wireless transmission module 12 serving to wirelessly transmit the received remote control signal to a corresponding controlled device 22 (such as a television), in this embodiment, the wireless transmission module 12 being, but not limited to, an infrared transmission module for illustration purposes only, in practice, the wireless transmission module 12 being alternatively a radio transmission module or a laser transmission module;

304. the controlled device executing corresponding operation according to the received remote control signal, according to the received remote control signal, the controlled device 22 switching to the channel 2111 (such as channel 2) that the user desires to watch.

According to the operation method of the present invention, the user can browse the program list information 211 and immediately remote control the controlled device 22 to switch to the selected channel for watching a desired program. Therefore, the portable electronic device 10 can be conveniently used.

In conclusion, in comparison with the conventional technique, the present invention has the following advantages:
1. A user can browse (or check) the program list information on the portable electronic device and immediately remote control the controlled device 22 via the same device to switch to the selected channel for watching a desired program.
2. The portable electronic device can be conveniently used.

The present invention has been described with the above embodiments thereof and it is understood that many changes and modifications in the above embodiments can be carried out without departing from the scope and the spirit of the invention that is intended to be limited only by the appended claims.

What is claimed is:

1. An electronic program list operation system applied to portable electronic device, comprising:
at least one controlled device, which executes corresponding operation according to at least one received remote control signal;
at least one portable electronic device wirelessly connected to a network platform for readily downloading and updating a program list information transmitted from the network platform, the portable electronic device including a microprocessor unit, a storage unit and a display input unit, the storage unit storing therein at least one application software and at least one remote control code, the program list information being loaded in the application software, the remote control code being correspondingly connected to multiple channels in the program list information, the display input unit serving to display the program list information loaded in the application software for a user to check and input an operation command to select a desired channel, the microprocessor unit being connected to the storage unit and the display input unit, the microprocessor unit serving to receive the operation command and convert the remote control code corresponding to the selected channel into at least one remote control signal; and
a wireless transmission module electrically connected to the portable electronic device for receiving the remote control signal and transmitting the remote control signal to the controlled device.

2. The electronic program list operation system applied to portable electronic device as claimed in claim 1, wherein the program list information contains multiple program contents and time data, the program contents and time data corresponding to the channels.

3. The electronic program list operation system applied to portable electronic device as claimed in claim 2, wherein the remote control encoding data of the controlled device correspond to the remote control codes.

4. The electronic program list operation system applied to portable electronic device as claimed in claim 1, wherein the network platform includes a database for storing and organizing multiple television station program data, the network platform being connected to multiple television stations for readily updating the program data of every television station in the database and converting the program data into the program list information.

5. The electronic program list operation system applied to portable electronic device as claimed in claim 1, wherein the wireless transmission module has a mating section and a transmission member, the mating section being electrically mated with a connection section of the portable electronic device, the transmission member serving to receive the remote control signal from the microprocessor unit and transmit the remote control signal to the controlled device.

6. The electronic program list operation system applied to portable electronic device as claimed in claim 1, wherein the wireless transmission module is selected from a group consisting of an infrared transmission module, a radio transmission module and a laser transmission module, the wireless transmission module being disposed on one side of the portable electronic device.

7. The electronic program list operation system applied to portable electronic device as claimed in claim 5, wherein the transmission member is selected from a group consisting of an infrared transmission member, a radio transmission member and a laser transmission member.

8. The electronic program list operation system applied to portable electronic device as claimed in claim 1, wherein the portable electronic device is selected from a group consisting of an intelligent cell phone, a tablet, a notebook and a personal digital assistant.

9. The electronic program list operation system applied to portable electronic device as claimed in claim 4, wherein the network platform is a network store or a server.

10. An electronic program list operation method applied to portable electronic device, the portable electronic device being wirelessly connected to a network platform, the portable electronic device including a microprocessor unit, a storage unit and a display input unit, the storage unit storing therein at least one application software and at least one remote control code, the electronic program list operation method comprising steps of:
using the portable electronic device to readily download and update program list information transmitted from the network platform and loading the program list information into the application software;
displaying the program list information in the application software via the display input unit for a user to check and input an operation command to select desired channels;
using the microprocessor unit to receive the operation command and convert the remote control codes corresponding to the selected channels in the program list information into at least one remote control signal, a wireless transmission module being used to transmit the remote control signal to a corresponding controlled device; and
the controlled device executing corresponding operation according to the received remote control signal.

11. The electronic program list operation method applied to portable electronic device as claimed in claim 10, further comprising a step of providing the network platform and connecting the network platform to multiple television stations for readily updating the program data of every television station that are stored in a database of the network platform and converting the program data into the program list information before the step of using the portable electronic device to readily download and update the program list information transmitted from the network platform and loading the program list information into the application software.

12. The electronic program list operation method applied to portable electronic device as claimed in claim 10, wherein the program list information contains multiple program contents and time data, the program contents and time data corresponding to the channels.

13. The electronic program list operation method applied to portable electronic device as claimed in claim 10, wherein the wireless transmission module is selected from a group consisting of an infrared transmission module, a radio transmission module and a laser transmission module.
